(19) United States
(12) Patent Application Publication
(10) Pub. No.: US 2017/0161725 A1
(43) Pub. Date: Jun. 8, 2017

(54) SYSTEMS AND METHODS FOR DELIVERING A PAYMENT CARD

(71) Applicant: MasterCard International Incorporated, Purchase, NY (US)

(72) Inventors: Adam Kenneth Hosp, Lake Saint Louis, MO (US); Matthew R. Stocke, Glendale, MO (US); David Colby Brown, Dardenne Prairie, MO (US); Nevada Alpine Kent, V, Rock Hill, MO (US); Michael K. Forbis, Saint Louis, MO (US)

(21) Appl. No.: 14/956,982

(22) Filed: Dec. 2, 2015

(51) Int. Cl. G06Q 20/34; G06Q 20/40

(52) U.S. Cl. CPC G06Q 20/354; G06Q 20/40145

(57) ABSTRACT

Embodiments of the disclosure enable a card issuer to deliver and deliver payment cards in an organized and secure manner. In one aspect, a computer-implemented method and system for delivering a payment card is provided. The method and system include identifying a location of a client device associated with a request for the payment card. A first zone about the client device is scanned for one or more objects in the first zone. A determination is made as to whether at least one predetermined object of the one or more objects is associated with the payment card. On condition that the at least one predetermined object is associated with the payment card, the payment card is delivered. Aspects of the disclosure enable a card issuer to activate and deliver payment cards in an organized and secure manner.

### FIELD OF DISCLOSURE

The subject matter described herein relates generally to payment card delivery, and more specifically, to using geolocation, routing, and/or biometric data to deliver and/or deliver the payment card.

### BACKGROUND

Delivering a payment card establishes or continues a relationship between a payment card issuer and an account holder. Some payment card delivery processes include verifying that a recipient of a new or replacement payment card is an intended recipient of the payment card. Traditionally, the issuer mails the payment card to an address of the account holder (e.g., an address on record) and, upon receipt, the recipient calls a telephone number to deliver the payment card. In at least some payment card delivery processes, the recipient is prompted to provide a card number and/or other verification information. In some circumstances, a payment card is mailed while the account holder is away from the address on record. Such circumstances may leave the account holder without access to the payment card and/or expose the payment card to theft while the account holder is away from the address on record.

### SUMMARY

Embodiments of the disclosure enable a payment card issuer to deliver and activate payment cards in an organized and secure manner. In one aspect, a computer-implemented method for delivering a payment card is provided. The method includes identifying a location of a client device associated with a request for the payment card. A first zone about the client device is scanned for one or more predefined objects in the first zone. A determination is made as to whether at least one object of the one or more predefined objects is associated with the payment card. On condition that the at least one object is associated with the payment card, the payment card is delivered to the at least one object associated with the payment card.

In another aspect, a computing device for delivering a payment card is provided. The computing device includes a memory storing data associated with one or more client devices, and computer-executable instructions, and a processor configured to execute the computer-executable instructions. The computer-executable instructions include identifying a location of at least one client device of the one or more client devices and scanning a first zone about the at least one client device for one or more predefined objects in the first zone. The computer-executable instructions also include determining whether at least one object of the one or more predefined objects is associated with the at least one client device, and, on condition that the at least one object is associated with the at least one client device, delivering the payment card.

In yet another aspect, a mobile-delivery computing device for delivering a payment card is provided. The mobile-delivery computing device includes a memory storing data and computer-executable instructions, and a processor configured to receive a location of a client device. The computer-executable instructions also include traveling to a first zone based at least in part on the location of the client device and travel to a first zone based at least in part on the location of the client device. The computer-executable instructions also include, upon arriving at a threshold distance from the client device, scanning the first zone for one or more predefined objects in the first zone and determining whether at least one object of the one or more predefined objects is associated with the payment card. On condition that the at least one object is associated with the payment card, the computer-executable instructions also include delivering the payment card.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an example block diagram illustrating an operating environment.

FIG. 2 is an example block diagram illustrating a server that may be used in an operating environment, such as the operating environment illustrated in FIG. 1.

FIG. 3 is an example block diagram illustrating a delivery device that may be used in an operating environment, such as the operating environment illustrated in FIG. 1.

FIG. 4 is an example block diagram illustrating a client device that may be used in an operating environment, such as the operating environment illustrated in FIG. 1.

FIG. 5 is an example flowchart illustrating a method for delivering and delivering a payment card.

FIG. 6 is an example flowchart illustrating a method for processing a request to deliver a payment card.

FIG. 7 is an example flowchart illustrating a method for delivering and activating a payment card.

FIG. 8 is an example block diagram illustrating a computing device.

FIG. 9 is an example block diagram illustrating a payment card processing network.

Corresponding reference characters indicate corresponding parts throughout the drawings.

### DETAILED DESCRIPTION

Embodiments of the disclosure enable a payment card to be delivered and/or activated using information processing, delivery routing, and/or biometric verification. Some embodiments provide for receiving a request for a new or replacement payment card at a server device. Regarding an example of payment card delivery, the server device may determine one or more delivery options for delivering the payment card to an account holder. For example, a delivery device may be used to deliver the payment card to a client device associated with the account holder. Some embodiments provide for biometrically verifying the account holder upon entering a first zone and delivering the payment card upon entering a second zone. Additionally, embodiments of the disclosure enable a delivery device to deliver a payment card to an account holder. Delivery may involve any type of transport a payment card, whether by land, sea, air, and/or space. Regarding an example of payment card delivery, a delivery device may receive a location of a client device, travel to a first zone based at least in part on the location of the client device, and upon arriving at a threshold distance from the client device, scan the first zone for one or more predefined objects in the first zone. Delivery may further comprise determining whether at least one object of the one or more predefined objects is associated with the payment card, and on condition that the at least one object is associated with the payment card, travel to a second zone and deliver the payment card to one of the one or more objects associated with the payment card within the second zone.

Aspects of the disclosure provide for effectively and efficiently delivering a payment card to an account holder (also referred to herein as a “cardholder”). For example, a delivery device carrying the payment card may be routed towards a client device associated with an account holder. In this manner, a new or replacement payment card may be delivered to the account holder while the account holder is away from an address on record. Moreover, aspects of the disclosure provide for reliably and securely delivering the payment card to the account holder. For example, the delivery device may scan an area about the client device to identify one or more objects, and determine whether the one or more objects are associated with a payment card account. In this manner, a new or replacement card may be delivered when one or more objects are associated with the payment card account or, conversely, not delivered when one or more objects are not associated with the payment card account.

The methods and systems described herein may be implemented using computer programming or engineering techniques including computer software, firmware, hardware or a combination or subset thereof. As described above, at least one technical problem with known delivery systems is the inability to reliably and securely deliver a payment card to an account holder to a location other than an address on record, for example when the cardholder client is not at his or her home or place of business. The systems and methods described herein address that technical problem. For example, by determining a location of a client device associated with an account holder, a payment card may be delivered directly to the account holder, who is likely to be proximate to the client device. One or more objects, including a recipient of the payment card, may be verified in real-time (or near real-time) to reduce a risk associated with delivering the payment card to a location other than an address on record. Various routing options and/or delivery resources, including third-party delivery providers, may also be considered when determining one or more delivery options to improve an efficiency, security, and/or accuracy of delivering the payment card to the account holder. Additionally, some embodiments may improve communication between systems and/or reduce network bandwidth usage by streamlining at least some communications, improve user efficiency and/or user interaction performance via user interface interaction, and/or reduce error rate by automating at least some operations. In some embodiments, the subject matter described herein may facilitate conserving memory, improving processor or data transmission security, and/or improving operating system resource allocation.

The technical effect of the systems and processes described herein is achieved by performing at least one of the following operations: a) receiving a request for a payment card; b) receiving location data associated with a client device; c) identifying a location of the client device; d) identifying one or more delivery devices for delivering the payment card to the identified location; e) scanning a first zone about the client device for one or more objects in the first zone; f) receiving biometric data associated with at least one object of the one or more objects; g) determining whether the at least one object of the one or more predetermined objects is associated with the payment card; h) determining whether the at least one object is authorized to receive the payment card; i) determining whether a second object of the one or more predetermined objects is associated with the payment card; j) delivering the payment card; k) delivering the payment card upon entering a second zone about the client device; l) transmitting a request to confirm delivery of the payment card; m) delivering the payment card upon receiving a confirmation of delivery; n) suspending delivery of the payment card; o) suspending delivery of the payment card; travelling to a first zone based at least in part on the location of the client device; and p) travelling to a second zone and delivering the payment card to one of the one or more predetermined objects associated with the payment card within the second zone.

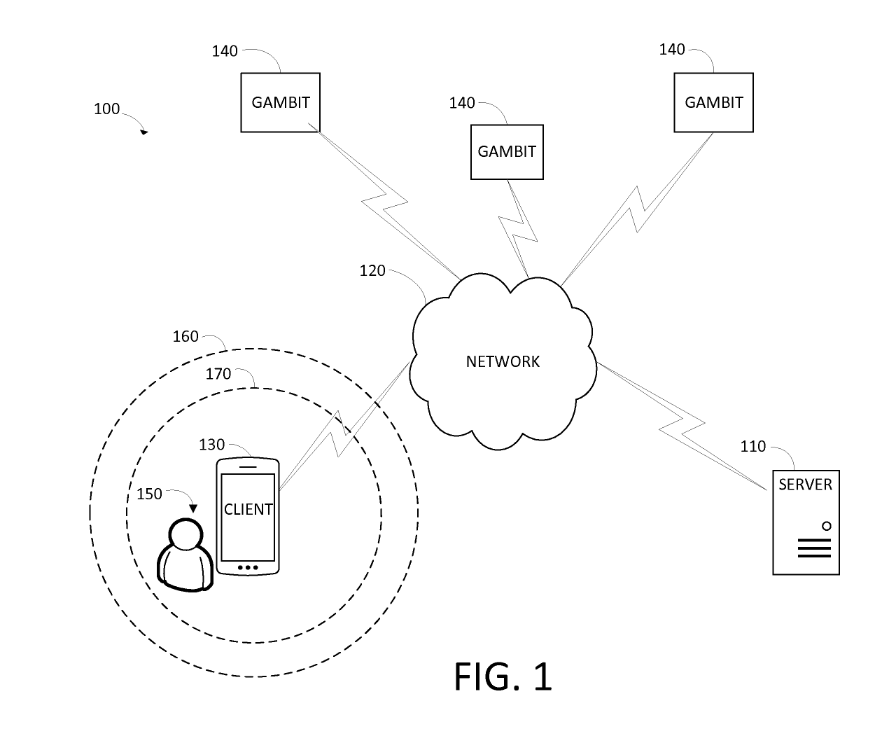

FIG. 1 is a block diagram illustrating an embodiment of an operating environment 100. The environment 100 includes one or more server devices or servers 110. The terms “server device” and “server” may be used interchangeably. The server 110 is configured to receive, store, and/or transmit data (such as routing data, biometric data, location data, payment card account data, etc.) with respect to other computing devices. For example, the server 110 may retrieve data stored at another computing device and store the retrieved data at the server 110. In some embodiments, the server 110 receives data from and/or transmit data to another computing device over a network 120. The network 120 may be the MasterCard® brand payment processing network (MasterCard® is a registered trademark of MasterCard International Incorporated located in Purchase, N.Y.). The MasterCard® brand payment processing network is a propriety network for exchanging financial transaction data between members of the MasterCard® brand payment processing network. Additionally or alternatively, the network 120 may include Transmission Control Protocol/Internet Protocol (TCP/IP) infrastructure to facilitate communication over the Internet.

In some embodiments, the server 110 is configured to process a request for a payment card. For example, the server 110 may receive the request for the payment card, identify a location of one or more computing devices (e.g., a client device or client 130) associated with a payment card account, identify one or more computing devices (e.g., a delivery device or delivery device 140) for delivering the payment card to the identified location, determine one or more routes for delivering the payment card, and/or activating the payment card. The terms “client device” and “client” may be used interchangeably. Moreover, the terms “delivery device” and “gambit” may be used interchangeably.

The client 130 is configured to receive data from and/or transmit data to another computing device (e.g., the server 110, the delivery device 140) over the network 120. For example, the client 130 is configured to receive, store, and/or transmit data (such as routing data, biometric data, location data, payment card account data, etc.) with respect to other computing devices (e.g., the server 110, the delivery device 140). The client may be, for example, a mobile device, a mobile telephone, a phablet, a tablet, a portable media player, a netbook, a laptop, a desktop computer, a computing pad, a kiosk, a tabletop device, an industrial control device, and other computing devices. In some embodiments, the client 130 is configured to receive input (e.g., a request for a payment card) from a user, wherein a user may be one type of object 150. The user may be a cardholder or, more broadly, an account holder. The terms “cardholder” and “account holder” may be used interchangeably herein. Moreover, the object 150 may include any physical object capable of being observed in any suitable manner, such as visually (camera lens, night-vision, infra-red, human eye, etc.), audibly (voice recognition, sounds of movement, etc.), by scent, and/or any other observation technique (radio waves, RADAR, LIDAR, GPS, etc.).

The delivery device 140 is configured to receive data from and/or transmit data to another computing device (e.g., the server 110, the client 130) over the network 120. For example, the delivery device 140 is configured to receive, store, and/or transmit data (such as routing data, biometric data, location data, payment card account data, etc.) with respect to other computing devices (e.g., the server 110, the delivery device 140). In some embodiments, the delivery device 140 is configured to deliver a payment card to an account holder. For example, the delivery device 140 may receive a request for a payment card from the server 110 and/or the client 130 and/or determine one or more routes for delivering the payment card. Alternatively, the delivery device 140 may receive routing data from the server 110, where the request for the payment card is received and the one or more routes are determined for delivering the payment card.

The delivery device 140 is configured to navigate space such that the payment card may be delivered to an account holder. In some embodiments, the delivery device 140 is configured to record and/or transmit delivery device data, such as position data, audio, video, trajectory data, and/or any other data. For example, the delivery device 140 may transmit delivery device data to the server 110 and/or to the client 130.

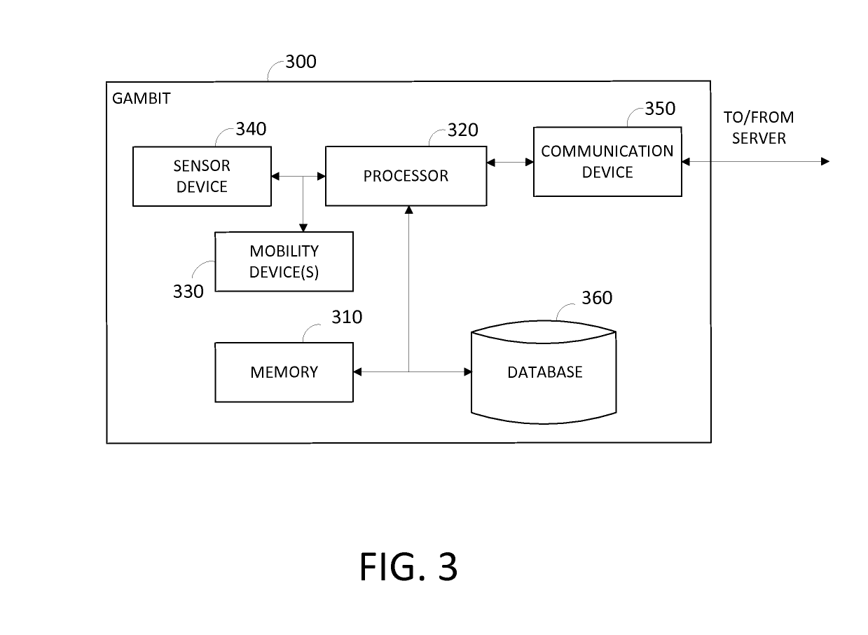

In some embodiments, the delivery device 140 is configured to determine whether a recipient is authorized to receive the payment card. For example, the delivery device 140 may perform a biometric scan of an object 150 (e.g., a user) to obtain scan data. A biometric scanner, as discussed in more detail below (sensor device 340 in FIG. 3), may include an image sensor, an audio senor, a temperature sensor, etc., and may be attached to or embedded within the delivery device 140.

The delivery device may receive biometric data associated with the payment card account from the server 110, and compare the scan data to the received biometric data to determine whether the object 150 is associated with the cardholder account. Alternatively, the delivery device 140 may obtain scan data, transmit the scan data (via radiowaves, TCP/IP, satellite communications, etc.) to the server 110, where the scan data is compared to biometric data associated with the payment card, and receive results data associated with the comparison of the scan data to the biometric data from the server 110.

The payment card may be delivered upon delivery of the payment card to an object 150 (e.g., an account holder). In some embodiments, the environment 100 includes one or more delivery zones 160, 170. Upon reaching or entering a first delivery zone 160, for example, the delivery device 140 may perform a biometric scan of one or more objects 150 in the first delivery zone 160. Upon verifying an identity of an object 150, the delivery device 140 may approach the object 150. Upon reaching or entering a second delivery zone 170, the delivery device 140 may deliver the payment card. One or more delivery zones 160, 170 may be determined by the server 110, the client 130, and/or the delivery device 140 based on a location of the client 130, which may change as the client 130 moves. For example, a GPS feed from the client 130 may be used to continuously monitor and update the location of the object 150. In some embodiments, the second delivery zone 170 is a subset of the first delivery zone 160, where both are centered upon the location of the client 130.

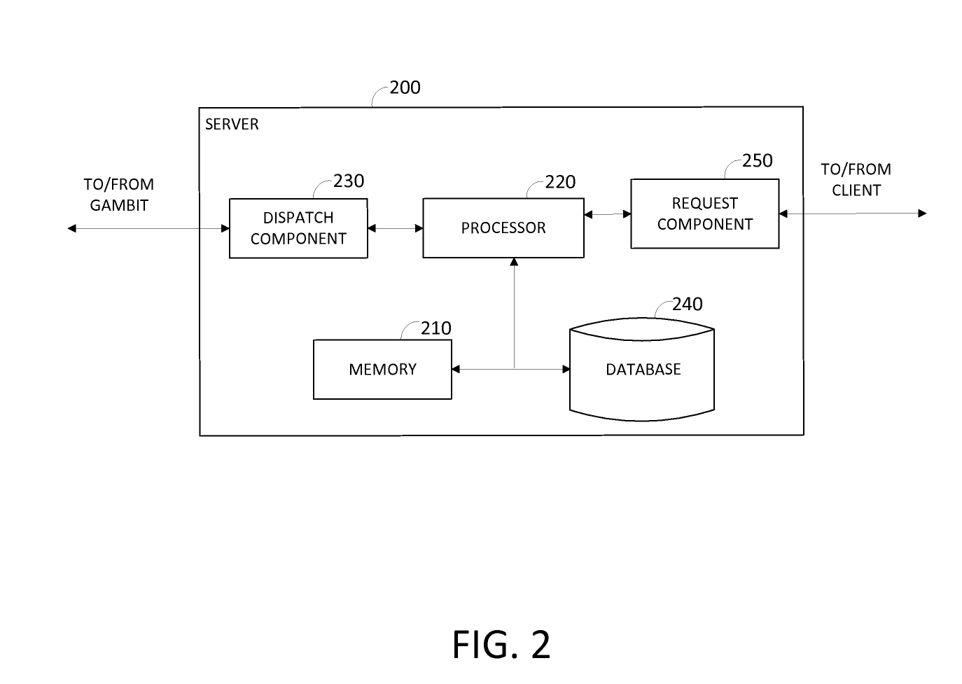

FIG. 2 is a block diagram illustrating an embodiment of a server 110 that may be used to send data to and/or receive data from one or more clients 130 and/or one or more delivery devices 140 in an environment 100 (shown in FIG. 1). While some embodiments of the disclosure are illustrated and described herein with reference to the server 110 being or including the server 110, aspects of the disclosure are operable with any computing device (e.g., client 130, delivery device 140) that executes instructions to implement the operations and functionality associated with the server 110.

For example, the server 110 may include a mainframe, legacy system, rack-mounted computer, mobile device, a mobile telephone, a phablet, a tablet, a portable media player, a netbook, a laptop, a desktop computer, a computing pad, a kiosk, a tabletop device, an industrial control device, and other computing devices. The server 110 may represent a group of processing units or other computing devices. Additionally, the server 110 may be configured to perform any operation described herein including one or more operations described herein as being performed by another computing device.

The server 110 includes one or more computer-readable media, such as a memory or memory area 210. The memory area 210 may include any quantity of media associated with or accessible by another component within the server 110 and/or by another computing device (e.g., a client 130, a delivery device 140). The memory area 210 may be internal to the server 110, external to the server 110 (not shown), or both (not shown). The memory area 210 may include one or more computer-executable instructions that are executable by a processor 220 that includes any quantity of processing units.

The server 110 includes one or more dispatch components 230 for exchanging data between the server 110 and one or more computing devices (e.g., delivery device 140). Examples of communication channels include Bluetooth®, Wi-Fi®, Zigbee®, 3G, 4G, long-term evolution (LTE®), near-field communication (NFC), radiowave, TCP/IP, etc. Bluetooth® is a registered trademark of Bluetooth Sig, Inc. Wi-Fi® is a registered trademark of Wi-Fi Alliance. Zigbee® is a registered trademark of Zigbee Alliance Corporation. LTE® is a registered trademark of Institut Européen des Normes. For example, the dispatch component 230 may track and record position data, audio, video, trajectory data, and/or any other data associated with the delivery device 140. Any combination of this data may be stored within the server 110, which may include storage within the memory area 210 and/or one or more databases 240 coupled to the memory area 210. The dispatch component 230 may communicate with any number of delivery devices 140 and/or modes of transportation including, for example, aircraft, automobile, amphibious vehicle, vessels or other watercraft, spacecraft, and any other mobile vehicle or craft. The dispatch component 230 may communicate with communication equipment in any other device, such as with other servers coordinating delivery devices 140 and/or any other types of modes of transportation.

The one or more databases 240 are configured to store data that is retrievable by another component within the server 110 (e.g., memory 210, processor 220, dispatch component 230) and/or by another computing device (e.g., a client 130, a delivery device 140). The database 240 may be any type of database, such as centralized, decentralized, distributed, remote, cloud-based, and the like. Any type of data may be stored, such as data received from one or more delivery devices 140 and/or one or more clients 130. The database 240 may reside within the memory 210, outside the memory 210 within the server 110, or outside the server 110.

The server 110 includes at least one request component 250 for exchanging data between the server 110 and one or more computing devices (e.g., client 130). For example, the server 110 may be coupled to another computing device via a network (e.g., network 120, the Internet) to facilitate communication with the other computing device. Communication between the server 110 and a computer-readable media or another computing device may occur using any protocol or mechanism over any wired or wireless connection. For example, a request from the client 130 may be received by the request component 250, executed by the processor 220 as a query upon the database 240, whereupon the processor 220 may instruct the request component 250 to send the query results back to the client 130 and/or any other device.

The block diagram of FIG. 2 is merely illustrative of an embodiment of a system that may be used in connection with one or more embodiments of the disclosure and is not intended to be limiting in any way. Further, peripherals or components of the computing devices known in the art are not shown, but are operable with aspects of the disclosure. At least a portion of the functionality of the various elements in FIG. 2 may be performed by other elements in FIG. 2, or an entity (e.g., processor, web service, server, applications, computing device, etc.) not shown in FIG. 2.

FIG. 3 is a block diagram illustrating an embodiment of a delivery device 140 that may be used to receive a delivery request from a server 110, deliver a package (e.g., a payment card) to a target (e.g., client 130, object 150), verify or verify an identity of the target, and/or activate the package in an environment 100 (shown in FIG. 1). While some embodiments of the disclosure are illustrated and described herein with reference to the delivery device 140 being or including the delivery device 140, aspects of the disclosure are operable with any computing device (e.g., server 110, client 130) that executes instructions to implement the operations and functionality associated with the delivery device 140.

For example, the delivery device 140 may include any type of aircraft, automobile, amphibious vehicle, vessels or other watercraft, spacecraft, and any other mobile vehicle or craft that provide for the functionality described herein. The delivery device 140 may be unmanned or manned, autonomous and/or remotely controlled or commanded. In one embodiment, the delivery device 140 is an unmanned aerial drone, such as a quad-copter. In another embodiment, the delivery device 140 is a vehicle that is manned internally, with one or more operators at least partially controlling the delivery device 140 from within the delivery device 140, and/or manned externally (i.e., remotely controlled), with one or more operators at least partially controlling the delivery device from outside the delivery device. In some embodiments, the delivery device 140 is configurable to operate in an unmanned manner in some respects (e.g., during predefined or operator-specified time periods or for predetermined modes of operation) while being controlled by one or more operators in other respects. The delivery device 140 may represent a group of processing units or other computing devices. Additionally, the delivery device 140 may be configured to perform any operation described herein including one or more operations described herein as being performed by another computing device.

The delivery device 140 includes one or more computer-readable media, such as a memory or memory area 310. The memory area 310 may include any quantity of media associated with or accessible by another component within the delivery device 140 and/or by another computing device (e.g., a server 110, a client 130). The memory area 310 may be internal to the delivery device 140, external to the delivery device 140 (not shown), or both (not shown). The memory area 310 may include one or more computer-executable instructions that are executable by a processor 320 that includes any quantity of processing units.

The delivery device 140 includes one or more mobility devices 330 for providing movement for the delivery device 140. As described above, the delivery device 140 may be any type of vehicle or craft. The mobility device 330 may include a rotor, a propeller, a turbine, a wheel, an engine, a chain, a reactor, a sail, or any other device configured to generate, sustain, modify, slow, and/or stop a movement of the delivery device 140. The one or more mobility devices 330 may take on any characteristic such as permanent, retractable, removable, and/or disposable, and be fabricated from any combination of materials.

The delivery device 140 includes one or more sensor devices 340 for detecting one or more ambient conditions. The sensor device 340 may include, for example, an image sensor (e.g., standard spectrum camera, infrared camera, etc.), an audio sensor (e.g., microphone), a motion sensor (e.g., accelerometer), a location sensor (e.g., compass, GPS), obstacle avoidance sensor (e.g., sonar, radio frequency, etc.), a temperature sensor (e.g., thermometer), and/or a radiation sensor (e.g., Geiger-counter) or the like. The sensor device 340 may have on-board processing capabilities for tasks such as biometric identification (e.g., facial recognition, voice recognition), and location and route calculation. Alternatively, the sensor device 340 may communicate with another component within the delivery device 140 (e.g., memory 310, processor 320, mobility device 330) and/or another computing device (e.g., server 110, client 130) to process one or more tasks.

The delivery device 140 may include one or more communication devices 350 (such as radio-frequency devices, TCP/IP communication devices, satellite communication devices, wi-fi devices, cellular devices, infrared radiation wireless devices, etc.) for exchanging data between the delivery device 140 and another computing device (e.g., server 110). For example, the delivery device 140 may be coupled to another computing device via a network (e.g., network 120, the Internet) to facilitate communication with the other computing device. Communication between the delivery device 140 and a computer-readable media or another computing device may occur using any protocol or mechanism over any wired or wireless connection.

The delivery device 140 includes one or more databases 360 configured to store data that is retrievable by another component within the delivery device 140 (e.g., memory 310, processor 320, mobility device 330, sensor 340, communication device 350) and/or by another computing device (e.g., server 110, client 130). The database 360 may be any type of database, such as centralized, decentralized, distributed, remote, cloud-based, and the like. Any type of data may be stored, such as data received from one or more servers 110 and/or one or more clients 130. The database 360 may reside within the memory 310, outside the memory 310 within the delivery device 140, or outside the delivery device 140.

The block diagram of FIG. 3 is merely illustrative of an embodiment of a system that may be used in connection with one or more embodiments of the disclosure and is not intended to be limiting in any way. Further, peripherals or components of the mobile objects known in the art are not shown, but are operable with aspects of the disclosure. At least a portion of the functionality of the various elements in FIG. 3 may be performed by other elements in FIG. 3, or an entity not shown in FIG. 3.

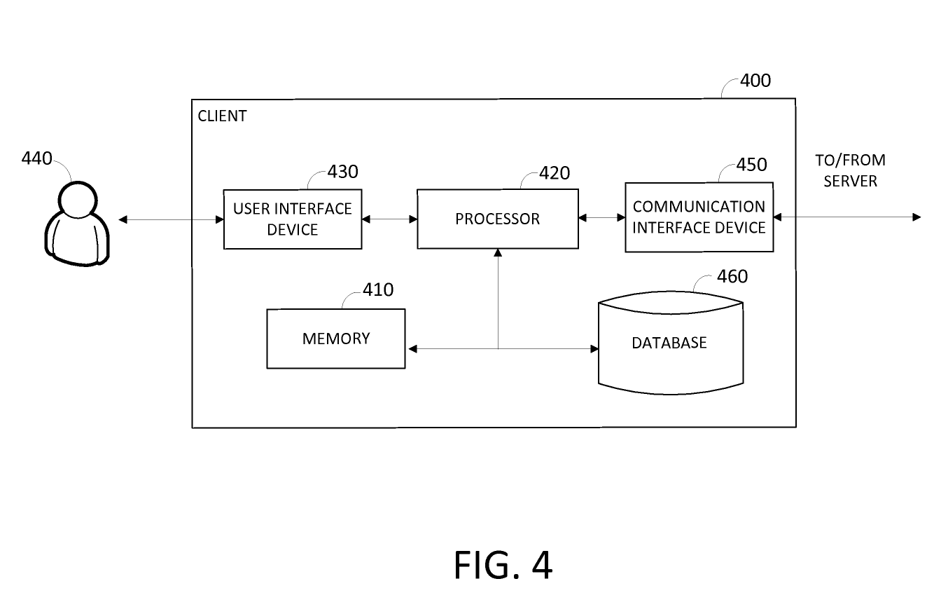

FIG. 4 is a block diagram illustrating an embodiment of a client 130 that may be used to send data to and/or receive data from one or more servers 110 and/or one or more delivery devices 140 in an environment 100 (shown in FIG. 1). While some embodiments of the disclosure are illustrated and described herein with reference to the client 130 being or including the client 130, aspects of the disclosure are operable with any computing device (e.g., server 110, delivery device 140) that executes instructions to implement the operations and functionality associated with the client 130.

The client 130 may represent a group of processing units or other computing devices. Additionally, the client 130 may be configured to perform any operation described herein including one or more operations described herein as being performed by another computing device.

The client 130 includes one or more computer-readable media, such as a memory or memory area 410. The memory area 410 may include any quantity of media associated with or accessible by another component within the client 130 and/or by another computing device (e.g., a server 110, a delivery device 140). The memory area 410 may be internal to the client 130, external to the client 130 (not shown), or both (not shown). The memory area 410 may include one or more computer-executable instructions that are executable by a processor 420 that includes any quantity of processing units.

The client 130 includes one or more user interface devices 430 for exchanging data between the client 130 and a user 440 (e.g., object 150), such as an account holder. For example, the user interface 430 includes, or is coupled to, a presentation device configured to present information, such as text, images, audio, video, graphics, alerts, and the like, to the user 440. The presentation device may include, without limitation, a display, a speaker, or a vibrating component. Additionally or alternatively, the user interface 430 may include or be coupled to an input device (not shown) configured to receive information, such as user commands, from the user 440. The input device may include, without limitation, a controller, a camera, a microphone, or an accelerometer. In at least some embodiments, the presentation device and the input device are integrated in a common user interface device 430 configured to present information to the user 440 and receive information from the user 440. For example, the user interface 430 may include, without limitation, a capacitive touch screen display or a controller including a vibrating component. In some embodiments, the user 440 may interface with the client 130 via another computing device.

The client 130 includes one or more communication interface devices 450 for exchanging data between the client 130 and another computing device (e.g., server 110, delivery device 150). For example, the client 130 may be coupled to any other device via a network (e.g., network 120, the Internet) to facilitate communication with the other computing device. Communication between the client 130 and a computer-readable media or another computing device may occur using any protocol or mechanism over any wired or wireless connection.

The client 130 may include one or more databases 460 configured to store data that is retrievable by another component within the client 130 (e.g., memory 410, processor 420, user interface device 430, communication interface device 450) and/or by another computing device (e.g., server 110, delivery device 150). The database 460 may be any type of database, such as centralized, decentralized, distributed, remote, cloud-based, and the like. Any type of data may be stored, such as data received from one or more servers 110 and/or one or more delivery devices 150. The database 460 may reside within the memory 410, outside the memory 410 within the client 130, or outside the client 130.

The block diagram of FIG. 4 is merely illustrative of an embodiment of a system that may be used in connection with one or more embodiments of the disclosure and is not intended to be limiting in any way. Further, peripherals or components of the computing devices known in the art are not shown, but are operable with aspects of the disclosure. At least a portion of the functionality of the various elements in FIG. 4 may be performed by other elements in FIG. 4, or an entity (e.g., processor, web service, server, applications, computing device, etc.) not shown in FIG. 4.

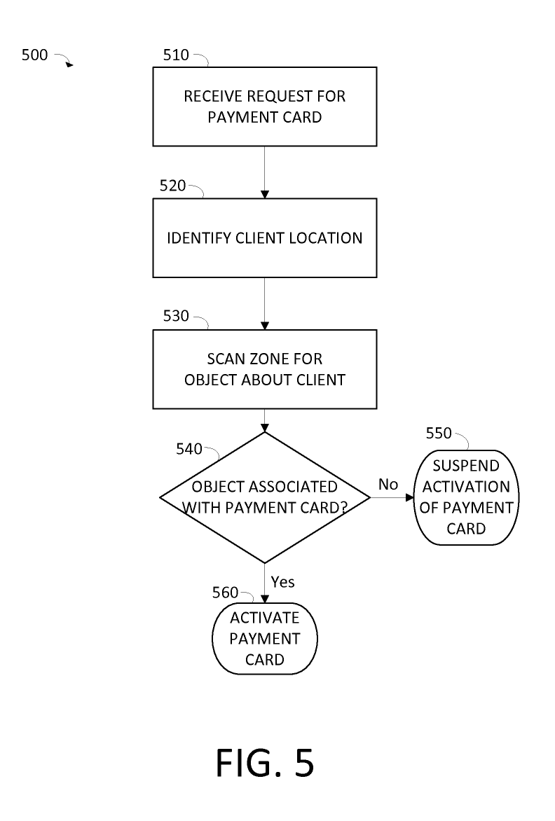

FIG. 5 is a flowchart of an embodiment of a method 500 of payment card delivery and activation in an environment 100 (shown in FIG. 1). In at least some embodiments, the server 110 receives a payment card request at 510. The payment card request may be sent from a client 130 and, in some embodiments, may include location data associated with the client 130 and/or biometric data associated with an authorized account holder. The server 110 identifies the client location at 520. For example, the server 110 may identify the client location based on the location data received from the client 130.

In some embodiments, an object is verified when the client 130 is at least a predetermined distance from a location associated with a cardholder account (e.g., an address of record). For example, if the payment card delivery request is sent when the client 130 is at least the predetermined distance from the address of record, the request may be flagged for further inquiry/investigation (e.g., biometric scan). In some embodiments, a refusal of the further inquiry/investigation may result in an automatic decline for the request, a delay, and/or a contact from a representative. At least some embodiments may include a tutorial or wizard that guides, at the client 130, an account holder about the inquiry/investigation.

To verify the object 150, the delivery device 140 approaches the identified client location and scans a first delivery zone 160 about the client 130 for an object 150 at 530. For example, the delivery device 140 may use a sensor (e.g., sensor 340) to scan the first delivery zone 160. If the object 150 is detected, the server 110 determines whether the detected object 150 is associated with a payment card or payment card account at 540. Upon determining that the detected object 150 is not associated with the payment card account (e.g., the object 150 is not authorized to receive a payment card), delivery or activation of the payment card may be suspended or cancelled at 550. On the other hand, upon determining that the detected object 150 is associated with the payment card account (e.g., the object 150 is authorized to receive the payment card), the payment card is delivered or activated at 560. If no object 150 is detected, delivery or activation of the payment card may be suspended or cancelled. Cancellation of the delivery terminates the process such that there is no further scanning, verification, delivery, and/or activation activity without another request for a payment card. Suspension of the delivery temporarily halts or pauses the process such that scanning, verification, delivery, and/or activation activity is resumed after a period of time or upon detecting a triggering event (e.g., the object leaving the first delivery zone 160, another object 150 entering the first delivery zone 160). In some embodiments, delivery or activation of the payment card is cancelled if the object 150 is not associated with the payment card account, and delivery or activation of the payment card is suspended if no object 150 is detected.

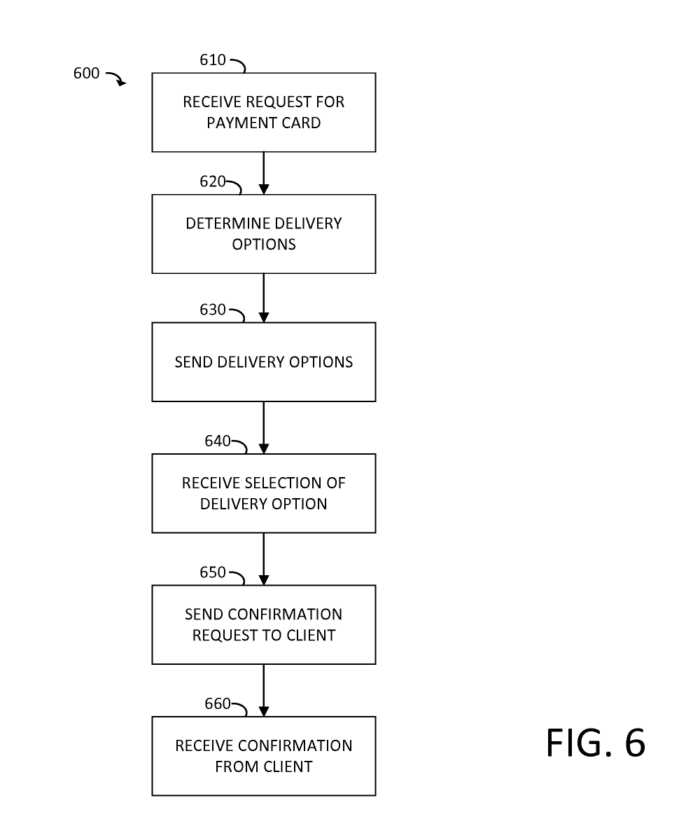

FIG. 6 is a flowchart of an embodiment of a method 600 of delivery request processing in an environment 100 (shown in FIG. 1). A request for a payment card is received at 610. The request for the payment card may be sent from a client 130 and, in some embodiments, may include location data associated with the client 130 and/or biometric data associated with an authorized account holder. For example, the client 130 may include a location sensor (e.g., GPS) that automatically generates location data that is included in and/or transmitted with the request for the payment card. Additionally or alternatively, the location data may be generated based on user input. For example, an account holder may input a location at the client 130 and/or select a location from one or more locations presented on the client 130. In some embodiments, the account holder may input a plurality of locations in order of preference, in preference tiers, or in any other manner that indicates a preference.

At 620, one or more delivery options are determined. In some embodiments, the server 110 determines the one or more delivery options based on a first location of a package (e.g., an origin) and a second location of the package (e.g., a target). The first location may be a fixed location (such as a manufacturing facility) or a mobile location. The second location may be a current location of the client 130 or a projected location of the client 130. In some embodiments, a delivery option may utilize one or more modes of transportation (e.g., aircraft, automobile, amphibious vehicle, vessels or other watercraft, spacecraft, and any other mobile vehicle or craft) to transport the package a distance between the first location and the second location. Each delivery option may be associated with a delivery time and/or a delivery cost. In some embodiments, the delivery time and/or the delivery cost are determined based at least in part on the location data and/or an availability of one or more modes of transportation.

In some embodiments, the delivery options are sent to the client 130 for presentation to a user (e.g., account holder) at 630, and a selection of one or more delivery options is received from the client 130 at 640. For example, the client 130 may present the delivery options with one or more parameters (e.g., a delivery time, a delivery cost) associated with the delivery option and receive user input that identifies the selection of one or more delivery options. Alternatively, the server 110 may automatically determine one or more delivery options based on the one or more parameters and/or one or more user preferences (e.g., fastest delivery, cheapest delivery).

The server 110 may send a confirmation request to the client 130 at 650, and receive a confirmation from the client 130 at 660. In some embodiments, the confirmation request includes confirmation data including a projected time of delivery (which may be a window of time), a projected delivery cost, and a projected delivery location (e.g., second location). In one embodiment, the server 110 sends one or more updates of the confirmation data to the client 130, and receive a request to modify and/or cancel the selected delivery option. Alternatively, the server 110 may automatically select another delivery option based on the update of the confirmation data and/or one or more user preferences.

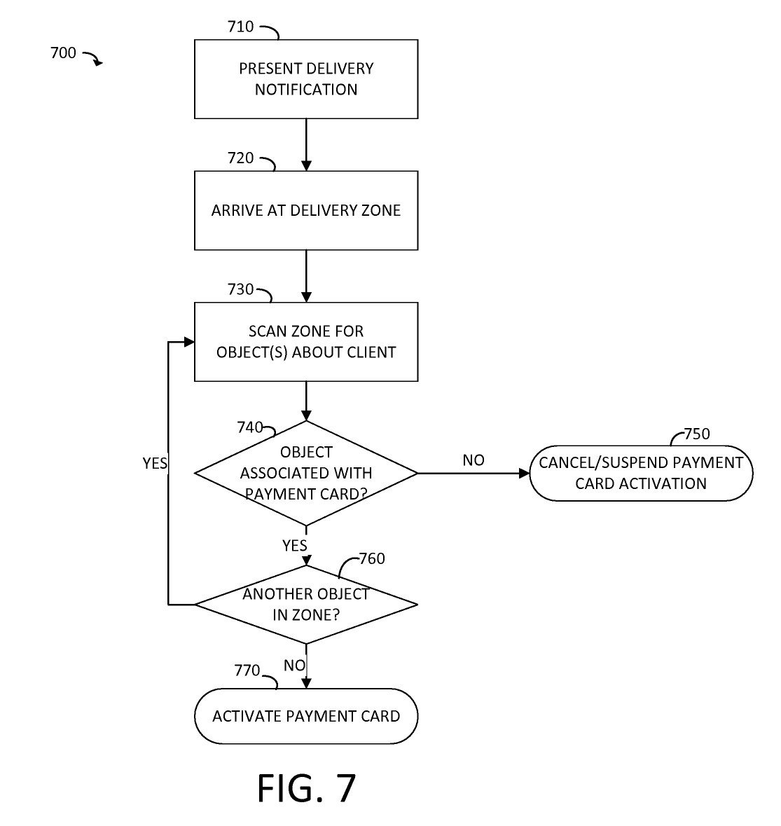

FIG. 7 is a flowchart of an embodiment of method 700 of payment card delivery and activation in an environment 100 (shown in FIG. 1). At 710, a delivery notification is presented to a user (e.g., account holder). The delivery notification may include an indication of the first delivery zone 160, such as a circular (or any other shape) geographic area. For example, the first delivery zone 160 may be denoted by the delivery device 140 via visual and/or audio indications (e.g., laser, spotlight, tones). In some embodiments, one or more delivery zones 160 or 170 may be selected from a plurality of delivery zones 160 and 170. Alternatively, the delivery zones 160 and/or 170 may be automatically determined based on a current location of the client 130. In some embodiments, the delivery notification may include, for example, a status log, location data, video, audio, a link, or other indicator presented on a client 130 that allows the user to track a delivery of a package (e.g., payment card). For example, the client 130 may display a real-time (or near real-time) video and/or audio feed from a delivery device 140, such as a drone, while it is en route.

At 720, the delivery device 140 arrives at or approaches the first delivery zone 170. In some embodiments, one or more boundaries of the first delivery zone 160 are specified by the delivery device 140 and/or the server 110. The delivery zones 160, 170 may have any shape or configuration that is specified by the client 140, the server 110, and/or the delivery device 140. In one embodiment, the first delivery zone 160 is established in relation to a radius about the client 130. The delivery zones 160, 170 may be spatially defined in terms of x-, y-, and/or z-axial representations and/or any mapping technology, such as GPS. Arrival of the delivery device 140 to the first delivery zone 160 may be approximate in nature, or specific to a certain distance outside, at, or inside a boundary of the first delivery zone 160.

At 730, a scan of the first delivery zone 160 is performed. For example, the scan may be performed by the delivery device 140. The scan may be used to identify one or more objects 150 (e.g., persons) within the first delivery zone 160. If there are a plurality of objects 150, the objects 150 may be scanned in any order, including sequentially and/or simultaneously. The order of scanning may be based on a predetermined algorithm and/or parameters, such as proximity to the delivery device 140, proximity to the client 130, size of the object 150, and the like.

At 740, it is determined whether an object 150 is associated with a payment card or payment card account. For example, a biometric scan (e.g., facial recognition, iris recognition, fingerprint recognition, movement recognition, voice recognition) may be conducted to generate scan data, and the scan data may be compared with biometric data associated with the payment card account to determine whether the object 150 is associated with the payment card account. In some embodiments, the delivery device 140 identifies all objects 150 within (or near) the first delivery zone 160 and determines whether all objects 150 are associated with the payment card account. Alternatively, the delivery device 140 may identify one object 150 within (or near) the first delivery zone and determine whether the one object 150 is associated with the payment card account. The one object 150 may be identified, for example, based on a predetermined algorithm and/or parameters, such as proximity to the delivery device 140, proximity to the client 130, size of the object 150, and the like.

If the object 150 is not associated with the payment card account or is not authorized to receive the payment card, delivery or activation of the payment card may be suspended for a period of time or cancelled at 750. If the object 150 is associated with the payment card account or is authorized to receive the payment card, it is determined at 760 whether another object 150 is within the first delivery zone 160. If another object 150 is within the first delivery zone 160, the delivery device 140 may scan the first delivery zone 160 and/or determine whether the other object is associated with the payment card. On the other hand, if there is no other object 150 within the first delivery zone 160, the payment card is delivered or activated at 770. The payment card may be activated before, during, or after receipt of the payment card by a recipient.

In one embodiment, if any object 150 in the first delivery zone 160 is not verified or authenticated, then the delivery or activation of the payment card is cancelled or suspended. Alternatively, the payment card may be delivered or activated based on the verification of one object 150. In some embodiments, a user may be notified of the objects 150 in the first delivery zone 160 and/or prompted to provide confirmation or permission to proceed with the activation or delivery of the payment card. Additionally or alternatively, a score that is indicative of a risk associated with one or more objects 150 in the first delivery zone 160 may be determined to facilitate determining whether to proceed with the activation or delivery of the payment card.

In some embodiments, a second delivery zone 170 may be utilized for delivery or verification of the payment card. For example, the payment card may be activated or delivered when the delivery device 140 arrives at or approaches the second delivery zone 170. In some embodiments, the delivery of the payment card may include dropping the payment card near the client 130 and/or verified object 150, lowering the payment card through a retraction mechanism, propelling the payment card through a fluid (e.g., air, liquid).

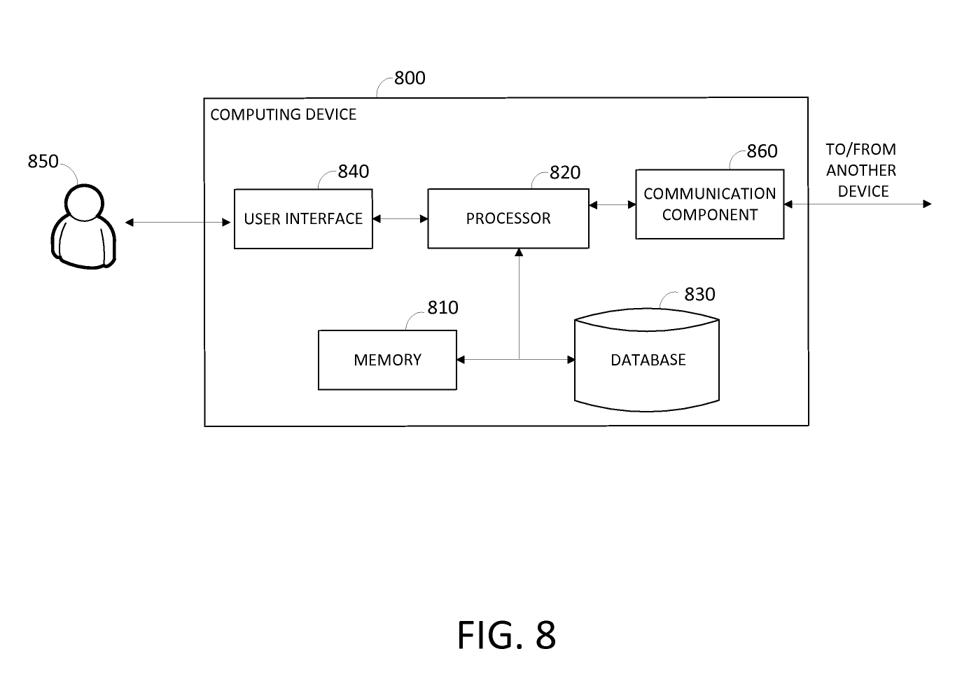

FIG. 8 is a block diagram illustrating an example computing device 800 that can be representative of one or more devices in an environment 100 (shown in FIG. 1). While some embodiments of the disclosure are illustrated and described herein with reference to the computing device 800 being a computing device, aspects of the disclosure are operable with any computing device (e.g., server 110, client 130, delivery device 140) that executes instructions to implement the operations and functionality associated with the computing device 800.

For example, the computing device 800 may include a mobile device, a mobile telephone, a phablet, a tablet, a client device, a server device, a delivery device, a portable media player, a netbook, a laptop, a desktop computer, a computing pad, a kiosk, a tabletop device, an industrial control device, and other computing devices. The computing device 800 may represent a group of processing units or other computing devices. Additionally, any computing device described herein may be configured to perform any operation described herein including one or more operations described herein as being performed by another computing device.

The computing device 800 includes one or more computer-readable media, such as a memory area 810 (e.g., memory area 210, memory area 310, memory area 410) storing computer-executable instructions, cardholder account information (e.g., parameters, preferences, rules, thresholds), message data, security data, enrollment data, and other data, and one or more processors 820 programmed to execute the computer-executable instructions for implementing aspects of the disclosure. For example, the computing device 800 may include a dispatch component 230 (shown in FIG. 2) a request component 250 (shown in FIG. 2), a sensor device 340 (shown in FIG. 3), a mobility device 330 (shown in FIG. 3), a communication device 350 (shown in FIG. 3), a user interface device 430 (shown in FIG. 4), and/or a communication interface device 450 (shown in FIG. 4). The memory area 810 includes any quantity of media associated with or accessible by the computing device 800. The memory area 810 may be internal to the computing device 800 (as shown in FIG. 8), external to the computing device 800 (not shown), or both (not shown).

The processor 820 includes any quantity of processing units, and the instructions may be performed by the processor 820 or by multiple processors within the computing device 800 or performed by a processor external to the computing device 800. The processor 820 is programmed to execute instructions such as those illustrated in the figures (e.g., FIGS. 5, 6, and/or 7). Although the processor 820 is shown separate from the memory area 810, embodiments of the disclosure contemplate that the memory area 810 may be onboard the processor 820 such as in some embedded systems.

Upon programming or execution of these instructions, the processor 820 is transformed into a special purpose microprocessor or machine. For example, instructions in the server 110, when executed by the processor 220, may cause the processor 220 to generate a payment card request, send or receive a payment card request, process a payment card request, identify a location of a client, generate one or more delivery options, send or receive one or more delivery options, present one or more delivery options, generate a confirmation request, send or receive a confirmation request, present a confirmation request, send or receive confirmation data, send a zone about a client for one or more objects in the zone, determine whether an object is associated with a payment card, deliver and/or activate the payment card. Although the processor 220 is shown separate from the memory area 210, embodiments of the disclosure contemplate that the memory area 210 may be onboard the processor 220 such as in some embedded systems.

The computing device 800 includes at least one database 830. Any type of database, such as centralized, decentralized, distributed, remote, cloud-based, etc., may be utilized. Any type of data may be stored and retrieved, for example, the server 110 may include data received from one or more delivery devices 140 and/or one or more client devices 130. In another example, a request from a server 110 may be received by the communication device 350, executed by the processor 320 as a query upon the database 360, whereupon the processor 320 may instruct the communication device 350 to send the query results back to the server 110 and/or any other device. The database 360 may reside within the memory 310, outside the memory 310 within the delivery device 140, or outside the delivery device 140. In yet another example, in a client 130, a request from a server 110 may be received by the communication interface device 450, executed by the processor 420 as a query upon the database 460, whereupon the processor 420 may instruct the communication interface device 450 to send the query results back to the server 110 and/or any other device.

The computing device 800 includes at least one user interface 840 for exchanging data between the computing device 800 and a user 850. For example, the user interface 840 includes or is coupled to a presentation device configured to present information, such as text, images, audio, video, graphics, alerts, and the like, to the user 850. A user interface 840 can correspond to components in a server 110 (not shown), a delivery device 140 (not shown), and/or a client 130 (user interface device 430). The presentation device may include, without limitation, a display, a speaker, or a vibrating component. Additionally or alternatively, the user interface 840 may include or be coupled to an input device (not shown) configured to receive information, such as user commands, from the user 850. The input device may include, without limitation, a controller, a camera, a microphone, or an accelerometer. In at least some embodiments, the presentation device and the input device are integrated in a common user interface 840 configured to present information to the user 850 and receive information from the user 850. For example, the user-interface device may include, without limitation, a capacitive touch screen display or a controller including a vibrating component. In some embodiments, the user 850 may interface with the computing device 800 via another computing device.

The computing device 800 includes at least one communication component 860 for exchanging data between the computing device 800 and a computer-readable media or another computing device. For example, the communication component 860 may correspond to request component 250 in a server 110, communication device 350 in delivery device 140, and/or communication interface 450 in a client 130 via a network and/or the Internet. Communication between the computing device 800 and a computer-readable media or another computing device may occur using any protocol or mechanism over any wired or wireless connection.

The block diagram of FIG. 8 is merely illustrative of an example system that may be used in connection with one or more embodiments of the disclosure and is not intended to be limiting in any way. Further, peripherals or components of the computing devices known in the art are not shown, but are operable with aspects of the disclosure. At least a portion of the functionality of the various elements in FIG. 8 may be performed by other elements in FIG. 8, or an entity (e.g., web service, applications, etc.) not shown in FIG. 8.

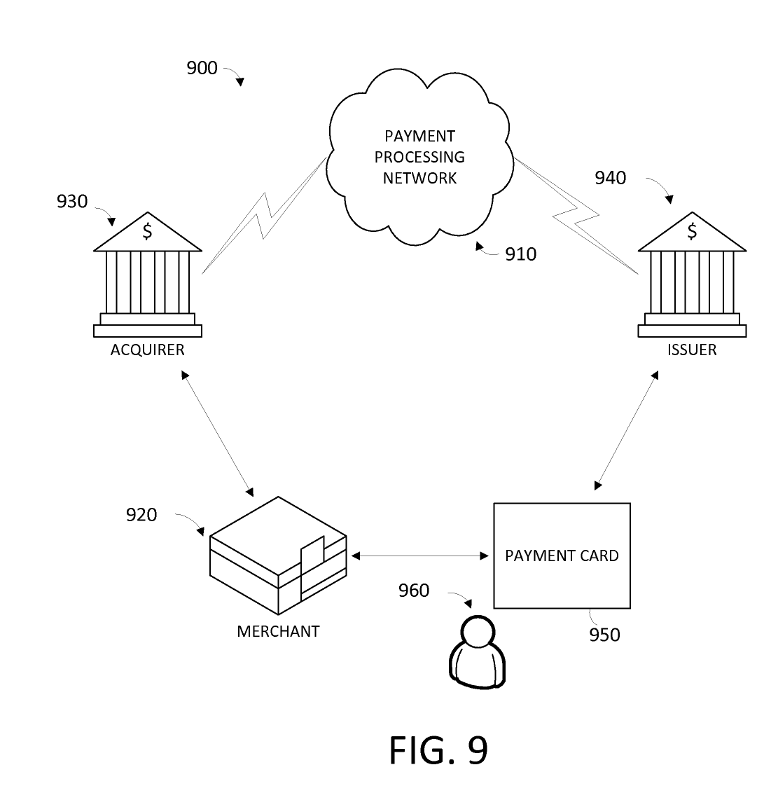

FIG. 9 is a block diagram illustrating an embodiment of a system or environment 900 for processing financial transactions. The environment 900 includes a processing network 910, such as the MasterCard® brand payment processing network (MasterCard® is a registered trademark of MasterCard International Incorporated located in Purchase, N.Y.). The MasterCard® brand payment processing network is a propriety network for exchanging financial transaction data between members of the MasterCard® brand payment processing network.

The environment 900 includes one or more merchants 920 that accept payment via the processing network 910. To accept payment via the processing network 910, the merchant 920 establishes a financial account with an acquirer 930 that is a member of the processing network 910. The acquirer 930 is a financial institution that maintains a relationship with one or more merchants 920 to enable the merchants 920 to accept payment via the processing network 910. The acquirer 930 may also be known as an acquiring bank, a processing bank, or a merchant bank.

The environment 900 includes one or more issuers 940 that issue or provide payment cards 950 (e.g., credit card, debit card, prepaid card, and the like) or other payment products to one or more cardholders 960 or, more broadly, account holders (“cardholder” and “account holder” may be used interchangeably herein). The issuer 940 is a financial institution that maintains a relationship with one or more cardholders 960 to enable the cardholders 960 to make a payment using the payment card 950 via the processing network 910.

A cardholder 960 uses a payment product, such as a payment card 950, to purchase a good or service from a merchant 920. In some embodiments, the payment card 950 is linked or associated with electronic wallet technology or contactless payment technology, such as a radio frequency identification (RFID)-enabled device, a Bluetooth® brand wireless technology-enabled device, a ZigBee® brand communication-enabled device, a Wi-Fi® brand local area wireless computing network-enabled device, a NFC wireless communication-enabled device, and/or any other device that enables the payment card 950 to purchase a good or service from a merchant 920. (Bluetooth® is a registered trademark of Bluetooth Special Interest Group, ZigBee® is a registered trademark of the ZigBee Alliance, and Wi-Fi® is a registered trademark of the Wi-Fi Alliance). The cardholder 960 may use any payment product that is linked or associated with a corresponding financial account maintained by an issuer 940. As described herein, the term “payment card” includes credit cards, debit cards, prepaid cards, digital cards, smart cards, and any other payment product that is linked or associated with a corresponding financial account maintained by an issuer 940. Payment cards 950 may have any shape, size, or configuration that enables the environment 900 to function as described herein.

A cardholder 960 may present the merchant 920 with a payment card 950 to make a payment to the merchant 920 in exchange for a good or service. Alternatively, the cardholder 960 may provide the merchant 920 with account information associated with the payment card 950 without physically presenting the payment card 950 (e.g., for remote financial transactions, including e-commerce transactions, card-not-present transactions, or card-on-file transactions). Account information may include a name of the cardholder 960, an account number, an expiration date, a security code (such as a card verification value (CVV), a card verification code (CVC), and the like), and/or a personal identification number (PIN).

The merchant 920 requests authorization from an acquirer 930 for at least the amount of the purchase. For example, the merchant 920 may request authorization through a point-of-sale (POS) terminal, which reads account information of the cardholder 960 from a microchip or magnetic stripe on the payment card 950, and transmits the cardholder's account information to one or more financial transaction processing computing devices of the acquirer 930. In another embodiment, the POS terminal reads account information of the cardholder 960 from a device configured to communicate with the POS terminal using contactless payment technology, and transmits the cardholder's account information to one or more financial transaction processing computing devices of the acquirer 930.

Using the processing network 910, the financial transaction processing computing devices of the acquirer 930 communicate with one or more financial transaction processing computing devices of an issuer 940 to determine whether the account information of the cardholder 960 matches or corresponds with the account information of the issuer 940, whether the account is in good standing, and/or whether the purchase is covered by (e.g., less than) a credit line or account balance associated with the financial account. Based on these determinations, the financial transaction processing computing devices of the issuer 940 determine whether to approve or decline the request for authorization from the merchant 920.

If the request for authorization is declined, the merchant 920 is notified as such, and may request authorization from the acquirer 930 for a lesser amount or request an alternative form of payment from the cardholder 960. If the request for authorization is approved, an authorization code is issued to the merchant 920, and the cardholder's available credit line or account balance is decreased. The financial transaction is then settled between the merchant 920, the acquirer 930, the issuer 940, and/or the cardholder 960. Settlement typically includes the acquirer 930 reimbursing the merchant 920 for selling the good or service, and the issuer 940 reimbursing the acquirer for reimbursing the merchant 920. When a credit card is used, the issuer 940 may bill the cardholder 960 to settle a financial account associated with the cardholder 960. When a debit or prepaid card is used, the issuer 940 may automatically withdraw funds from the account.

For example, an object 150 (here a user) in a park places a request on their client device 150 for a replacement payment card 950. The request includes the client's 130 current location, the request being sent over a network 120 via tcp/ip and is received by a server 110. The server 110 then communicates the request over a network 120 (which may not be the same network upon which the client sent the request) to multiple delivery devices 140. The delivery devices 140 report their locations to the server 110, and the server 110 selects the closest available delivery device 140. The server 110 sends a projected card delivery time and a delivery zone 170 to the client 130 as a confirmation request. Once the client 130 sends confirmation 110, the delivery commences. Once the delivery device 140 is within a certain distance of the delivery zone 170, the delivery device 140 scans for objects 150 within the zone. Once the delivery device 140 has determined that only authorized objects 150 (such as the user and any other objects that he user may have specified as being authorized), the delivery device 140 sends an updated map to the client 130 instructing the user 150 to enter a smaller, second zone 160, where the replacement payment card 950 is then dropped from the delivery device 140 down to the user 150, with the replacement payment card 950 being delivered and also activated.

Although described in connection with an example computing system environment, embodiments of the disclosure are capable of implementation with numerous other general purpose or special purpose computing system environments, configurations, or devices.

Example computer-readable media and/or devices include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this disclosure are not signals per se. Example computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Embodiments of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, earphones, and the like), network PCs, minicomputers, mainframe computers, distributed computing environments that include any of the above systems or devices, and the like. Such systems or devices may accept input from the cardholder in any way, including from input devices such as a keyboard or pointing device, via gesture input, proximity input (such as by hovering), and/or via voice input.

Embodiments of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a,” “an,” “the,” and “said” are intended to mean that there are one or more of the elements. Furthermore, references to an “embodiment” or “example” of the present disclosure are not intended to be interpreted as excluding the existence of additional embodiments or examples that also incorporate the recited features. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

In some embodiments, the operations illustrated in the drawings may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various embodiments with their associated operations, a person skilled in the art would appreciate that a combination of operations from any number of different embodiments is also within scope of the aspects of the disclosure.

What is claimed is:

1. A computer-implemented method for delivering a payment card via a delivery device, the computer-implemented method comprising:
identifying a location of a client device associated with a request for the payment card;
scanning a first zone about the location of the client device for one or more predetermined objects in the first zone;
determining whether at least one object of the one or more predetermined objects is associated with the payment card; and
on condition that the at least one object is associated with the payment card, delivering the payment card to the object associated with the payment card.

2. The computer-implemented method of claim 1, further comprising receiving the request for the payment card, the request including location data, wherein the location of the client device is identified based on the location data.

3. The computer-implemented method of claim 1, wherein scanning the first zone comprises receiving biometric data associated with the at least one object, and wherein determining whether the at least one object is associated with the payment card comprises determining whether the at least one object is authorized to receive the payment card based on the received biometric data.

4. The computer-implemented method of claim 1, wherein delivering the payment card comprises entering a second zone about the client device smaller than the first zone, wherein the payment card is delivered upon entering the second zone.

5. The computer-implemented method of claim 1, wherein delivering the payment card comprises:
transmitting, to the client device, a request to confirm delivery of the payment card; and
receiving, from the client device, a confirmation of delivery, wherein the payment card is delivered upon receiving the confirmation of delivery.

6. The computer-implemented method of claim 1, further comprising, on condition that the at least one object is not associated with the payment card, suspending delivery of the payment card.

7. The computer-implemented method of claim 1, further comprising:
determining whether a second object of the one or more predetermined objects is associated with the payment card; and
on condition that the second object is not associated with the payment card, suspending delivery of the payment card.

8. The computer-implemented method of claim 1, further comprising:
determining whether a second object of the one or more predetermined objects is associated with the payment card; and
on condition that the second object is not associated with the payment card, suspending delivery of the payment card.

9. The computer-implemented method of claim 1, further comprising:
receiving the request for the payment card; and
identifying one or more delivery devices for delivering the payment card to the identified location.

10. A computing device for delivering a payment card, the computing device comprising:
a memory storing data associated with one or more client devices, and computer-executable instructions; and
a processor configured to execute the computer-executable instructions to:
identify a location of at least one client device of the one or more client devices;
scan a first zone about the at least one client device for one or more predetermined objects in the first zone;
determine whether at least one object of the one or more predetermined objects is associated with the at least one client device; and
on condition that the at least one object is associated with the at least one client device, deliver the payment card.

11. The computing device of claim 10, wherein the processor is further configured to execute the computer-executable instructions to receive a request for the payment card, wherein the location of the at least one client device is identified upon receiving the request.

12. The computing device of claim 10, wherein the processor is further configured to execute the computer-executable instructions to:
receive biometric data associated with the at least one object; and
determine whether the at least one object is authorized to receive the payment card based on the received biometric data.

13. The computing device of claim 10, wherein the processor is further configured to execute the computer-executable instructions to:
enter a second zone about the client device smaller than the first zone, wherein the payment card is delivered upon entering the second zone.

14. The computing device of claim 10, wherein the processor is further configured to execute the computer-executable instructions to:
transmit, to the client device, a request to confirm delivery of the payment card; and
receive, from the client device, a confirmation of delivery, wherein the payment card is delivered upon receiving the confirmation of delivery.

15. The computing device of claim 10, wherein the processor is further configured to execute the computer-executable instructions to:
determine whether a second object of the one or more predetermined objects is associated with the payment card; and
on condition that the second object is not associated with the payment card, suspend one or more of activation of the payment card and delivery of the payment card.

16. The computing device of claim 10, wherein the processor is further configured to execute the computer-executable instructions to:
receive a request for the payment card; and
identify one or more delivery devices for delivering the payment card.

17. A mobile-delivery computing device for delivering a payment card, the mobile-delivery computing device comprising:
a memory storing data and computer-executable instructions; and
a processor configured to execute the computer-executable instructions to:
receive a location of a client device;
travel to a first zone based at least in part on the location of the client device;
upon arriving at a threshold distance from the client device, scan the first zone for one or more predetermined objects in the first zone;
determine whether at least one object of the one or more predetermined objects is associated with the payment card; and
on condition that the at least one object is associated with the payment card, travel to a second zone and deliver the payment card to one of the one or more objects associated with the payment card within the second zone.

18. The mobile-delivery computing device of claim 17, wherein, upon execution by the at least one processor, the computer-executable instructions further cause the processor to:
receive biometric data associated with the at least one object; and
determine whether the at least one object is authorized to receive the payment card based on the received biometric data.

19. The mobile-delivery computing device of claim 17, wherein the second zone about the client device smaller than the first zone.

20. The mobile-delivery computing device of claim 17, wherein, upon execution by the at least one processor, the computer-executable instructions further cause the processor to:
determine whether a second object of the one or more predetermined objects is associated with the payment card; and
on condition that the second object is not associated with the payment card, suspend one or more of delivery of the payment card and delivery of the payment card.
